(19) United States
(12) Patent Application Publication
(10) Pub. No.: US 2009/0129678 A1
(43) Pub. Date: May 21, 2009

(54) CONTENTS STORAGE APPARATUS AND CONTENTS STORAGE METHOD

(76) Inventors: Hiroko SUKEDA, Tokorozawa (JP); Youichi HORII, Mitaka (JP)

Correspondence Address: BRUNDIDGE & STANGER, P.C., 1700 DIAGONAL ROAD, SUITE 330, ALEXANDRIA, VA, 22314, US

(21) Appl. No.: 12/274,539

(22) Filed: Nov. 20, 2008

(30) Foreign Application Priority Data
Nov. 21, 2007 (JP) 2007-301166

(51) Int. Cl. G06K 9/00

(52) U.S. Cl. 382/181

(57) ABSTRACT

A method of providing metadata to easily and efficiently retrieve or manage contents data such as a video, an image, etc., having no metadata by means which is as user-friendly as possible, and a contents storage server (apparatus) are provided. Matching images for recognizing and specifying shot or broadcast time and time information thereof are prepared as a database for matching, time information which the whole video or image contents or a scene has is acquired by using the database for matching, and the acquired time information is provided to the contents as metadata, which facilitates retrieval or management of the contents.

### CLAIM OF PRIORITY

The present application claims priority from Japanese patent application JP2007-301166 filed on Nov. 21, 2007, the content of which is hereby incorporated by reference into this application.

### BACKGROUND OF THE INVENTION

The present invention relates to a contents storage apparatus (a server) for accumulating and managing various contents such as videos and images, in particular, to a method of providing additional information to contents in order to easily and efficiently make a program manage or retrieve, an apparatus for executing the method, and a service using the same.

The digitalization of various video and image contents including recorded television programs or images taken by digital cameras is developing rapidly. Recorded or downloaded digital contents are stored in a contents storage apparatus such as a hard disk or a DVD (digital versatile disk) and are used for watching or editing later. In this case, in order to access a desired content, a user performs a sort or a retrieval by using, as a key, additional data provided to the content, which allows (referred to as metadata) easy access in order to seek the contents which the user wants to watch. Specifically, the title of a program or a performer or to access desired contents using broadcast time or shot time as a key is generally used to retrieve data. Metadata is extracted or provided from information included in a video, or are provided by a receiving apparatus on the basis of EPG (electronic program guide) information when a digital television broadcast is recorded. Alternatively, apart from the video signal, metadata such as keywords divided for every scene may be distributed over a network. Moreover, there is known a technique of adding a variety of related information to various video data when a video is shot (see JP-A-Hei 8 (1996)-294080).

In consideration of the above invention, there is a growing need for digitalizing old analog contents and managing them as digital contents. Digitalizing analog contents improves the maintenance quality, prevents image quality from being deteriorated even if duplication is performed, and allows editing or processing, including copyright management and easy retrieval and the like. For example, contents can be stored in various media with minor degradations while saving the amount of space needed if it is stored on the hard disk as a digitalized file that may include the image of the TV program recorded in analog videotape, for example, the image of the home video taken with 8 mm video, and various pictures in a form of the negative film and the print and the like.

Meanwhile, a technique for detecting a part of a scene or extracting a representative scene or frame from arbitrary digital video contents has been developed (JP-A-2007-184674). Moreover, a technique for retrieving an image having a high degree of similarity with an extracted image by using the extracted image as a key (retrieving of a similar image) has been developed (JP-A-2003-224791). Retrieving of a similar image is basically a technique of extracting a similar image by calculating a specific amount from brightness or colors included in an image, shapes of shot objects, etc., and calculating the degrees of similarity among plural images.

### BRIEF SUMMARY OF THE INVENTION

When various video and image contents are stored in a storage medium and managed, if they are digital contents which have been provided with metadata in advance, retrieval or management using the provided metadata as a key is possible and convenient. However, when analog contents are digitalized, original analog contents are not provided with metadata related to programs or scenes. Moreover, even if the analog contents are digitalized, metadata is not automatically provided. Therefore, efficiency is decreased during the retrieval and management of metadata.

In order to facilitate retrieval and arrangement, it is possible to manually provide information such as the kind, title, broadcast time, recorded time of a video. However, human eyes need to watch a video in order to determine the time information so as to provide the time information. Therefore, manually providing metadata to analog data for a large amount of videos or pictures is not practical because time and efforts are required.

Accordingly, it is an object of the present invention to provide a method of providing metadata, to easily and efficiently retrieve or manage contents data such as a video, an image, etc., having no (or insufficient) metadata by means which is as user-friendly as possible (ultimately, automatically without any processes), and a contents storage server (apparatus) for executing the method.

In order to achieve the object, it is considered to extract a characteristic scene from contents data such as videos or images and to perform an image process and matching so as to automatically provide metadata. In particular, the first feature of the present invention is to provide time information (i.e., the shot time and broadcast time of a video, etc.), which is considered to be the best way to retrieve or manage metadata.

If watching a video or an image, human beings can understand which era it was shot (broadcasted) including assuming which era. This is because human beings can determine the information by roughly recognizing the era of the video or image from the background or characters included in the video or image on the basis of human common culture or individual experiences. According to the first feature of the present invention, information for recognizing and specifying an era from a video or an image is prepared as database for matching in advance, time information which the whole video or a scene is acquired by using the data for matching, and the acquired time information is provided to the contents as metadata, which facilitates retrieval or management of the contents.

According to an aspect of the present invention, a contents storage apparatus having a time information providing function includes a contents data storage unit for storing contents data, a metadata storage unit for storing metadata associated with the contents data, and a time information determination data storage unit for storing a matching image and time information associated with the matching image. The contents storage apparatus performs a process of matching an image included in the contents data with a matching image by a similar-image retrieving technique, a process of determining time information of the contents data from the results of the matching process, and a metadata providing process of providing time information associated with the matching image to the contents data. The provided time information is provided to a user as an estimated result.

When imported contents data is a video, a scene extracting technique extracts some of the representative images and these representative images are matched with matching images.

Further, in the matching process, a matching image having a high degree of similarity with an image included in the contents data is selected from the matching images stored in the time information determination data storage unit, and an operation process, which uses the degree of reliability and the degree of similarity of the time information associated with the selected matching image as variables, is performed. When plural matching images are selected, the operation process, which uses the degree of reliability and the degree of similarity of the time information associated with the selected matching image as variables, is performed on each matching image, and the cumulative total value of the operation process results for the individual matching images is obtained. It is possible to obtain the likelihood of the provided time information due to the operation process.

According to the first feature of the present invention, it is possible to provide a method of providing metadata, to easily and efficiently retrieve or manage video or image contents data having no (or insufficient) metadata by means which is as user-friendly as possible (ultimately, automatically without any processes, and a contents storage server (apparatus)). Therefore, when analog video or image contents such as videos recorded in analog video tapes or 8 mm video recorders or old photographs are digitalized and stored, it is possible to store them in a form which has high efficiency in retrieval, and convenience to the user is remarkably improved.

### BRIEF DESCRIPTION OF THE DRAWINGS

FIG. 1 is a diagram illustrating a structure of a whole system of a contents storage/retrieval apparatus according to a first exemplary embodiment of the prevent invention;

FIG. 2 is a diagram illustrating a structure of a server according to the first exemplary embodiment of the prevent invention;

FIG. 3 is a diagram illustrating an example of a format of metadata according to the first exemplary embodiment of the prevent invention;

FIG. 4 is a diagram illustrating an example of a time information determination database according to the first exemplary embodiment of the prevent invention;

FIG. 5 is a flow chart illustrating a contents storing/retrieving process according to the first exemplary embodiment of the prevent invention;

FIG. 6 is a diagram illustrating a procedure of a contents upload process according to the first exemplary embodiment of the prevent invention;

FIG. 7 is a diagram illustrating an example of a time information determination process according to the first exemplary embodiment of the prevent invention;

FIG. 8 is a diagram illustrating an example of metadata acquired in the time information determination process according to the first exemplary embodiment of the prevent invention;

FIG. 9 is a diagram illustrating an example of a screen display of a user-oriented terminal according to the first exemplary embodiment of the prevent invention;

FIG. 10 is a diagram illustrating another example of a screen display of a user-oriented terminal according to the first exemplary embodiment of the prevent invention;

FIG. 11 is a diagram illustrating examples of items of the time information determination database according to the first exemplary embodiment of the prevent invention;

FIG. 12 is a diagram illustrating a structure of a whole system of a contents storage/retrieval apparatus according to a second exemplary embodiment of the prevent invention; and

FIG. 13 is a flow chart illustrating a contents storing/retrieving process according to the second exemplary embodiment of the prevent invention.

### DETAILED DESCRIPTION OF THE INVENTION

### First Embodiment

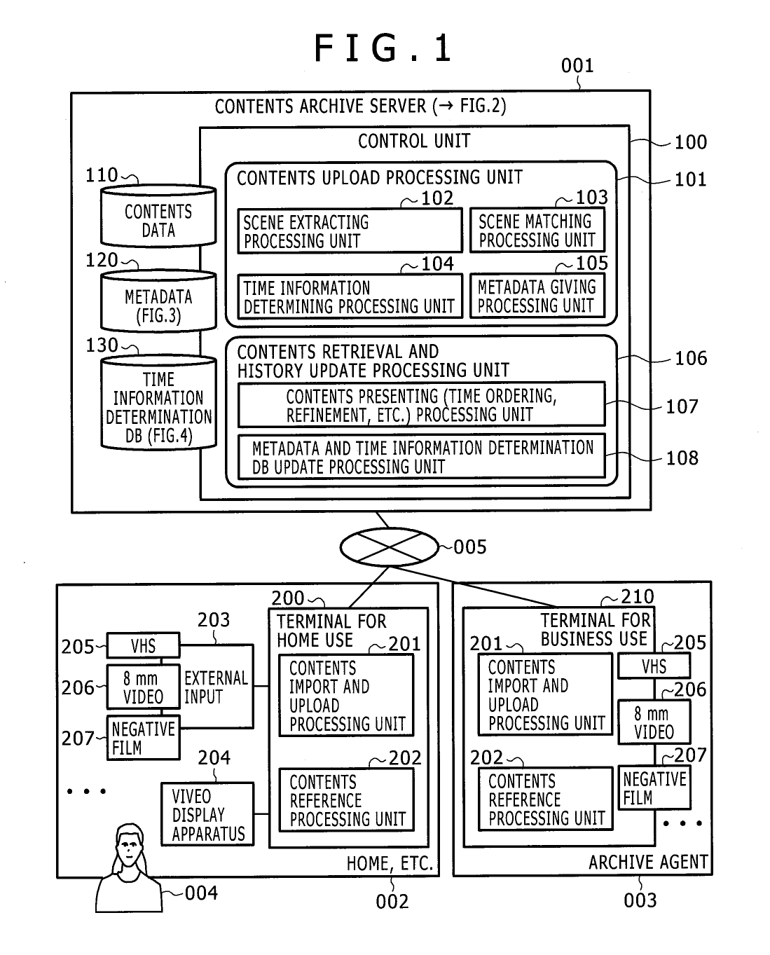

Hereinafter, a contents storage (retrieval) system according to a first exemplary embodiment of the present invention will be described with reference to FIGS. 1 to 11.

FIG. 1 shows a diagram illustrating a whole structure of a contents retrieval system according to the first exemplary embodiment of the prevent invention. In this exemplary embodiment, a service which arranges and stores a user's contents and metadata associated with the contents in a server called “a contents archive server” 001 is provided. In a home 002 of a user 004 or the like, a terminal 200 for home use is connected to the contents archive server 001 through a network 005. The terminal 200 for home use includes a processing unit 201 for per forming a contents import and upload process, and a processing unit 202 for referring to contents stored in the server, and has an external input load function 203 for importing various analog contents such as VHS videos 205, 8 mm videos 206, negative films 207, etc. The terminal may be configured to load not only analog contents but also digital contents such as videos of digital televisions or digital camera images as external inputs. Moreover, the terminal is connected to a video display apparatus 204 for watching contents stored in the server 001. Further, the same apparatus may be provided in an archive agent 003 as a terminal 210 for business use.

If the user 004 manually imports analog contents through the terminal 200 for home use, the contents import and upload processing unit 201 of the terminal 200 for home use digitalizes the imported analog contents and uploads the digital contents to the contents archive server 001 through the network 005. Alternatively, a service in which the agent 003 carries out the process as proxy may also be considered. When upload of a large amount of digital data through the network is not practical, a service in which the imported digital data is loaded into the server by mailing or delivering the digital data to the server may also be considered. A contents upload processing unit 101 performs scene extraction on the uploaded digital content, a scene matching processing unit 103 matches an extracted representative image with a matching image stored in a time information determination database 130, a process of determining time information of the contents is performed (104), and metadata is provided (105). The contents data and the metadata are stored in predetermined data storage spaces 110 and 120, respectively. The stored contents 110 can be retrieved or watched through a contents reference processing unit 202 of the terminal 200 for home use.

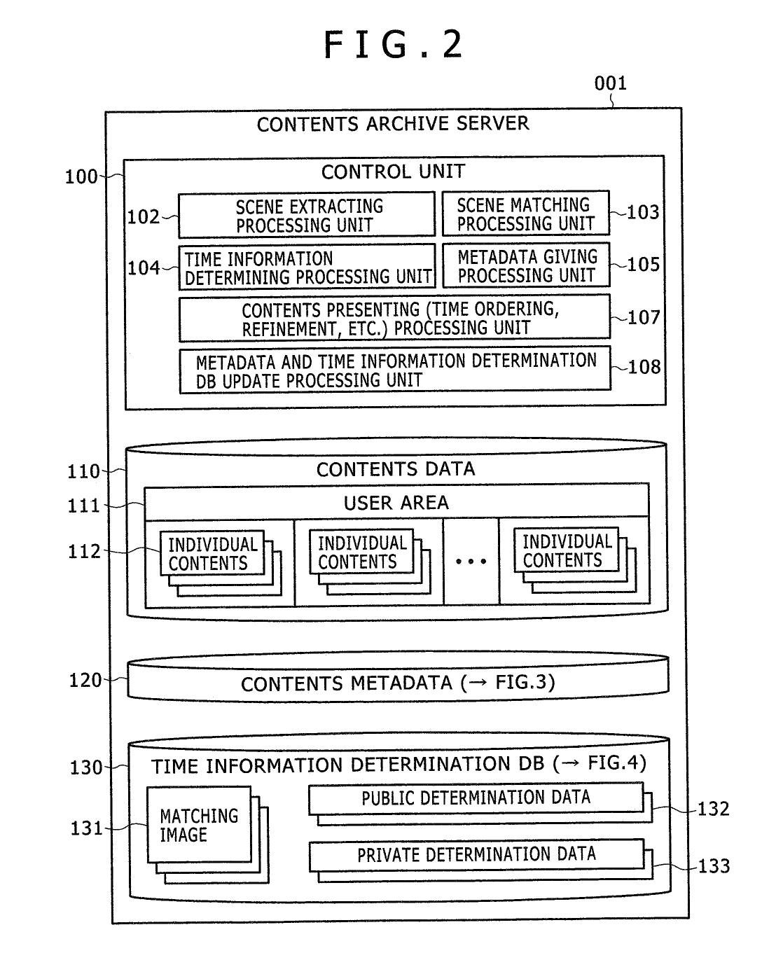

FIG. 2 shows the structure of the contents archive server 001 of FIG. 1 in more detail. A control unit 100 includes the scene extracting processing unit 102, the scene matching processing unit 103, time information determining processing unit 104, a metadata providing processing unit 105, a contents presenting processing unit 107, a metadata and time information determination DB update processing unit 108, and so on. Data stored in the server 001 is generally divided into three kinds. The first is a contents data storage unit 110 which stores imported digital contents, in which user areas 111 for users are prepared and individual contents 112 such as videos and images are stored. There is a storage unit 120 for storing metadata which is various additional information related to the contents. The structure and the like of the metadata will be described separately in detail. Moreover, there is a time information determination database 130 in order to store data for time information determination used to match scenes and provide time information, matching images 131 and information on an era and time which each of the matching images represents are stored in the time information determination database 130. Since the video and image contents loaded into the server 001 include public (sharable) contents such as broadcast programs (a copyright issue is required to be separately considered), and private (not sharable) contents such as a video shot by a person, in a database for matching, a public item 132 which can be used in common to all users and a private item 133 which can be used by only a specific user are prepared. Moreover, if a design is performed in consideration of the user's privacy so that public data can be matched to public contents and private contents and private data can be matched to only private contents of the owner of the private data, convenience is improved.

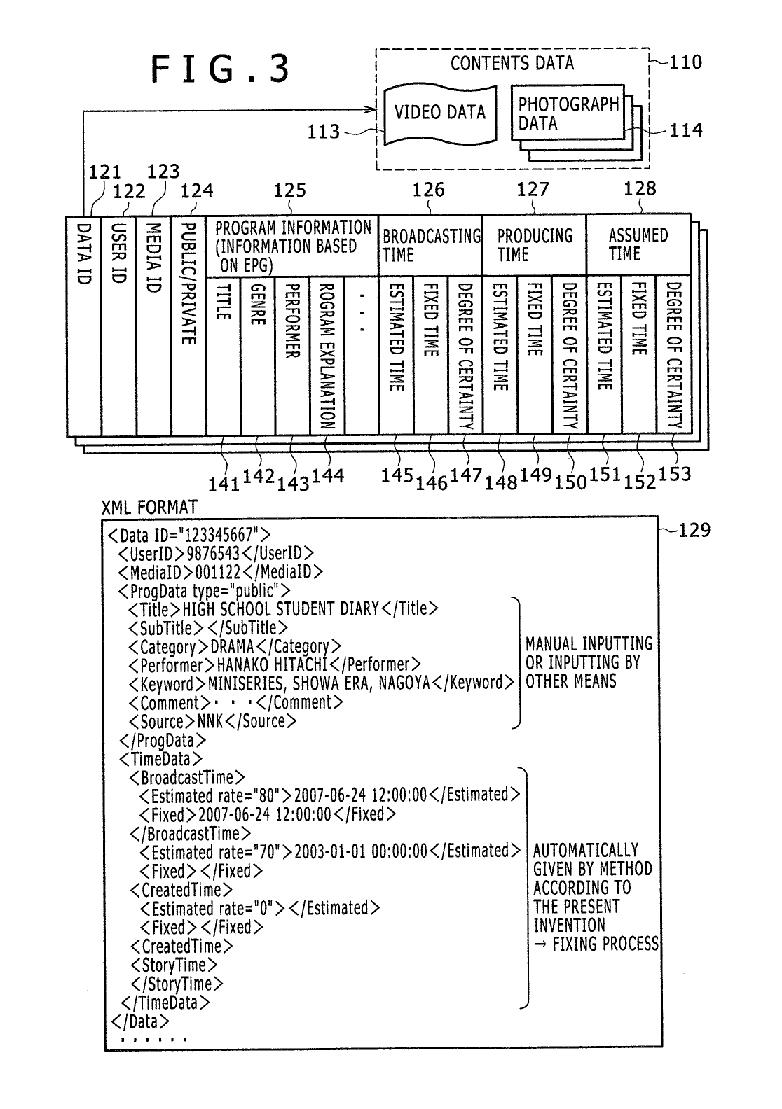

FIG. 3 shows a format of metadata (additional information) related to contents stored in the contents archive server and an example thereof. The metadata 120 includes a data ID 131 of contents data 110 related to the metadata, a user ID 122 of the owner of the content, an ID 123 of a original media, an identifier 124 representing whether the contents are public contents (such as a recorded broadcast program, etc.) or private contents (a video shot by a person, etc.), program information 125 according to EPG (the title or channel and performers of a program, etc., which is assumed to be input or provided manually or by means not disclosed in the present invention), and information on time of the content.

There are different kinds of time information depending on the kinds of videos or images. For example, three kinds are considered in relation to contents broadcast by a television, etc., as the following:

[A] Broadcast time 126: time when a program (content) was actually broadcasted (including rebroadcast time, etc.);

[B] Created time 127: time (an era) when a program (content) was created; and

[C] Story time 128: time (an era) when the setting of a program (content) was assumed.

Here, the term “time” may indicate an accurate time and date and may indicate a rough era having a range as “a oo era”. For example, if a drama set in the early Showa era was created in 1990 and was rebroadcasted in 2000, [A] is 2000, [B] is 1999, and [C] is the early Showa era. In the case of a live broadcast such as a newscast, [A], [B], and [C] are the same in general. In the case of a video or image shot by a person, the concept of [A] does not exist, and [B] and [C] are the same in general (however, in the case of a video or image acquired by shooting a play or the like performed on the assumption of a different era, [B] and [C] are not the same).

[A] holds an estimated time 145 automatically provided by a method according to an exemplary embodiment of the prevent invention, a degree of certainty thereof 147, and a fixed time 146 evaluated by a user, [B] holds an estimated time 148 automatically provided by a method according to an exemplary embodiment of the prevent invention, a degree of certainty thereof 150, and a fixed time 149 evaluated by a user, and [C] holds an estimated time 151 automatically provided by a method according to an exemplary embodiment of the prevent invention, a degree of certainty thereof 153, and a fixed time 152 evaluated by a user. The individual values are shown in, for example, an XML format as denoted by reference numeral 129.

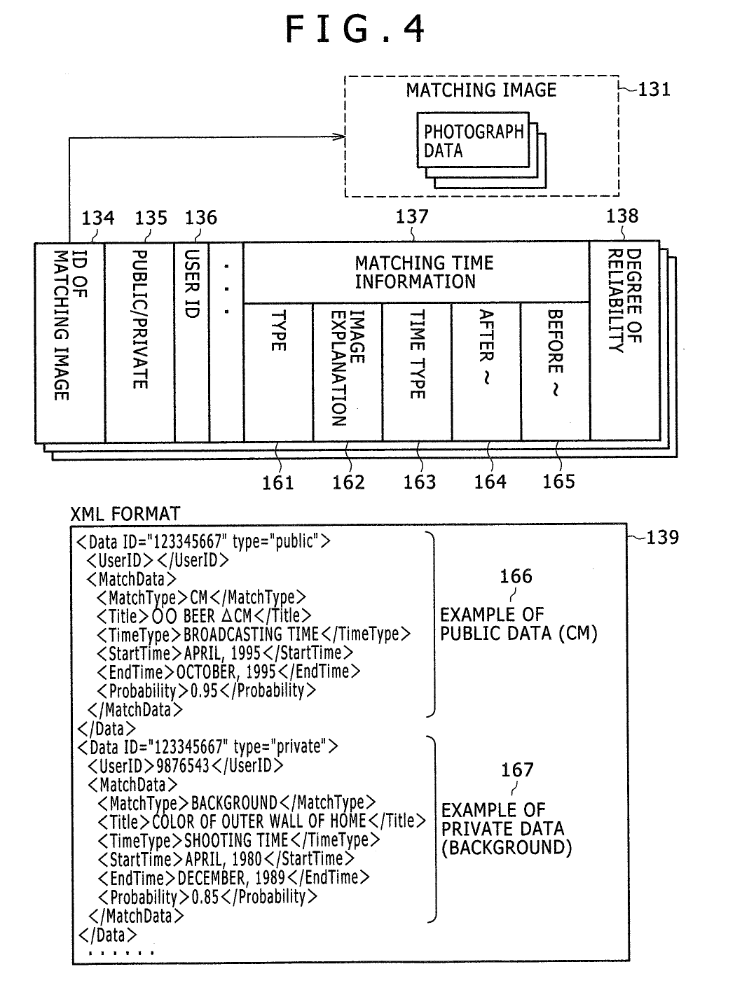

FIG. 4 shows an example of a structure of the time information determination database 130. Time determination data used to determine time information is associated to a matching image 131 registered in advance. The time determination data includes link to a matching image 134, an ID 135 representing whether the matching data is public data or private data. When the matching data is private data, the time determination data may include an ID 136 of a user of an object, information 137 on matching time, and a degree of reliability 138 of the matching time information. The information 137 on the matching time includes matching type 161 (representing a type such as a background image, a performer, a CM, etc.), explanation 162 of an original image, a time type 163 (corresponding any one of the broadcast time, the created time, and the background time), period start time 164 representing time when the matching starts, and period end time 165 representing time the matching finishes. Any one of the period start time 164 and the period end time 165 may be blank (for example, if time when the matching started is clear and the matching time includes current time but time when the matching will finish is not known, the period end time is not fixed). The degree of reliability 138 is an index representing a degree of reliability of an estimated time according to the matching and is represented in percents, a decimal, or in five steps. This value is appropriately corrected by evaluating the estimated result by a user.

FIG. 4 shows an example of the time determination data described in an XML format denoted by reference numeral 139. In an example 166 of public data, there is shown an example of data used to estimate broadcast time of the contents from data on a period when a CM included in a program and the like had been broadcasted. In an example 167 of private data, since a period when the contents had been shot is estimated from the color of the outer wall of a home reflected on the background and matching images used here belong to a person, a “Private” tag is provided and only contents having the ID of a user which is the owner are referred to.

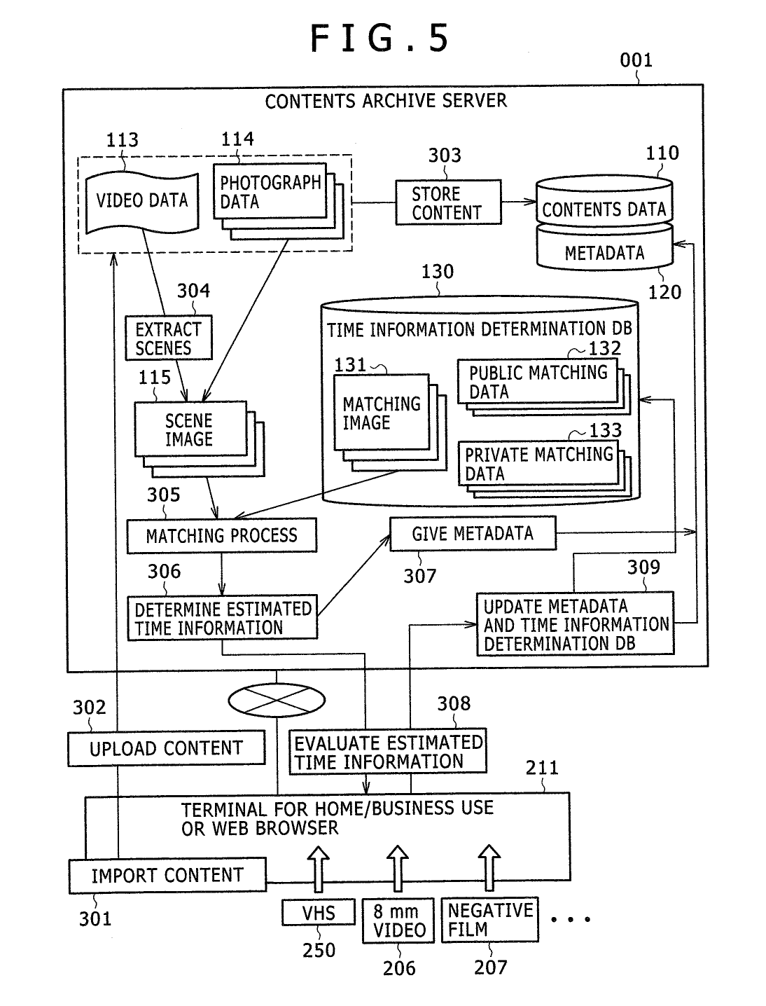

FIG. 5 shows a flow chart of a contents storage and retrieval process according to this exemplary embodiment. First, contents from a VHS 205, an 8 mm video recorder 206, a negative film 207, etc., is digitalized and loaded by using a terminal 211 for home or business use (301), and an upload process to the contents archive server 001 is performed through the network 005 or another means (302). The server 001 receives the contents and stores the original data of the contents as contents data 110 (303). If the contents are video data 113, a predetermined scene extracting process is performed (304), and conversion into a scene image 115 is performed. If the contents are a photograph 114, it becomes the scene image 115 without changes (here, a process such as removal of plural similar images, extracting of a characteristic image, etc. may be performed). Next, a matching process is performed on the scene image 115 and the matching image 131 by using a predetermined known similar-image retrieving technique (305), and estimated time information of the contents is provided by using the time determination match data 132 and 133 (306). The obtained estimated time information is stored as the metadata 120 (307). Further, the estimated result of the time information will be present to a user through a dedicated terminal or a Web browser 211 later and will be evaluated by the user (308). On the basis of the result, update of the metadata 120 and the time information determination database 130 will be performed (309). Therefore, improvement in the capability of learning and precision of the time information determination database 130 is achieved.

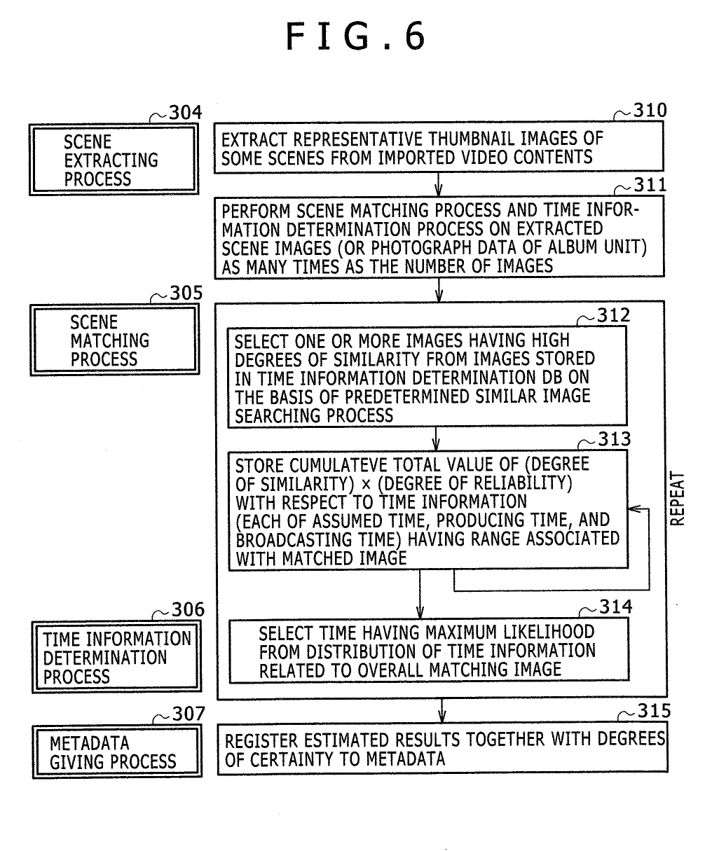

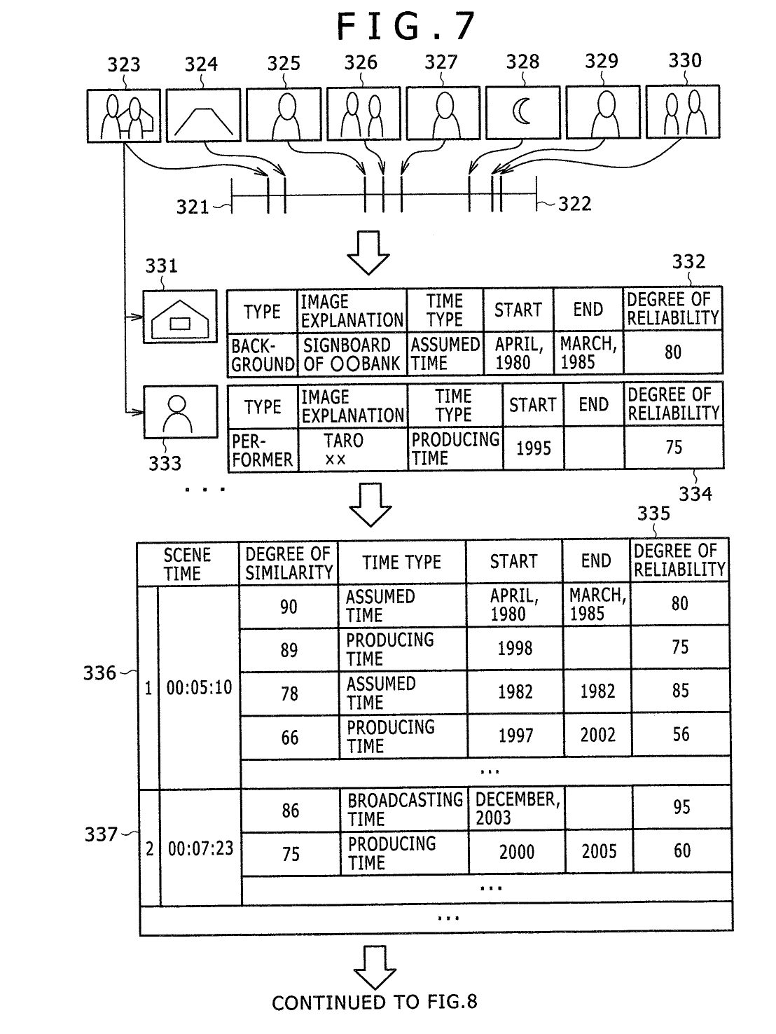

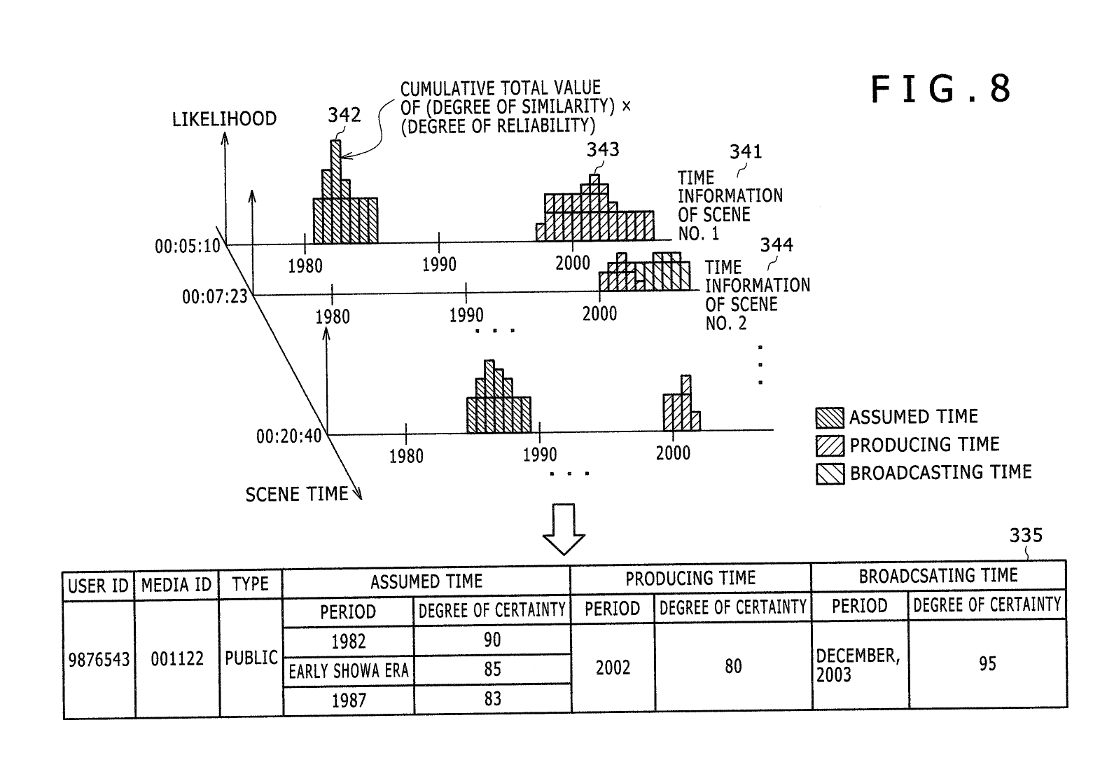

FIG. 6 shows a series of processes during contents upload. First, in a scene extracting process 304, representative images of some scenes are extracted from video contents by using an existing technique (310). The following “a scene matching process 305” and “a time information determination process 306” processes are performed on the extracted scene images as many times as the number of images (311). In a scene matching process, at least one image similar with the extracted images is selected from the matching images stored in the time information determination database on the basis of an existing similar-image retrieving technique (312). A cumulative total value of an operation in which a degree of similarity and a degree of reliability are variables, for example, a cumulative total value of (the degree of similarity)×(the degree of reliability) for time information associated with the matched images is temporarily stored for each of the story time, the created time, and the broadcast time (313). The process 313 is repeatedly performed on all of the matched images and a time (an era) having the highest likelihood is selected from the distribution of the time information (314). The processes 312 to 314 are repeatedly performed on all of the cut scene images so as to finally obtain the estimated results (the story time, the created time, and the broadcast time) for the whole video, and the estimated results are registered in the metadata (315). FIGS. 7 and 8 show an example of a time information determination process on the basis of the processes shown in FIG. 6. Characteristic thumbnail images 323 to 330 are extracted from the start 321 to the end 322 of the video by a predetermined scene extracting process and a similar image retrieving process is performed on each of the thumbnail images. As a result, the matching images are referred to in the order of high degree of similarity for the thumbnail image 323. An image 331 is associated with matching data 332 and an image 333 is associated with matching data 334. The matching data 332 defines that the image shows a signboard of a OO bank and thus the image was created against a time period from April 1980 to March 1985 when the oo bank had existed, and indicates the degree of reliability is 80%. Further, the matching data 334 defines that the image was created after 1995 when a performer's debut was made and indicates that the degree of reliability is 75%. Therefore, those data pieces are accumulated to make a list as shown by reference numeral 335 in FIG. 7. This represents that a first scene image 1 (323) that elapses 5 minutes 10 seconds from the start time hits an image, defining the degree of reliability of a story time to 80%, by a degree of similarity of 90%, when the first scene image hits an image, defining the degree of reliability of a created time to 75%, by a degree of similarity of 89%, and so on (336). Similarly, the result in which a second scene image 324 that elapses 7 minutes 23 seconds hits an image defining broadcast time or created time is shown (337) (which is continued to FIG. 8).

If the cumulative total value of (the degree of similarity)×(the degree of reliability) is plotted from a set of the matching data obtained in the above-mentioned manner, a graph as shown in FIG. 8 is acquired. In other words, if the cumulative total value of (the degree of similarity)×(the degree of reliability) for the matching data related to each story time with respect to the first scene image 1 (323) is plotted, it can be seen that a high peak exists in about 1982 (342), it can be seen that a peak exists in about 2002 with respect to the created time (343). Similarly, if an operation of performing pickup of time becoming the highest peak for every scene image is repeatedly performed and time information having the highest likelihood (time information having a peak of the cumulative total value in the whole program) is extracted, metadata including estimated results as shown by reference numeral 345 in FIG. 8 is obtained. Here, the created time or the broadcast time is converged to a specific period. However, in the case of the story time (particularly in a drama, a video, etc.), since a scene in which time goes back or a scene extending over plural eras exists, plural story times can be mixed.

The process example described with reference to FIGS. 7 and 8 show an example of a video contents of a program recorded. However, in the case of an image or a video recorded by a person, on the basis of a user ID, determination of time information is performed by using public matching data and private matching data of the user.

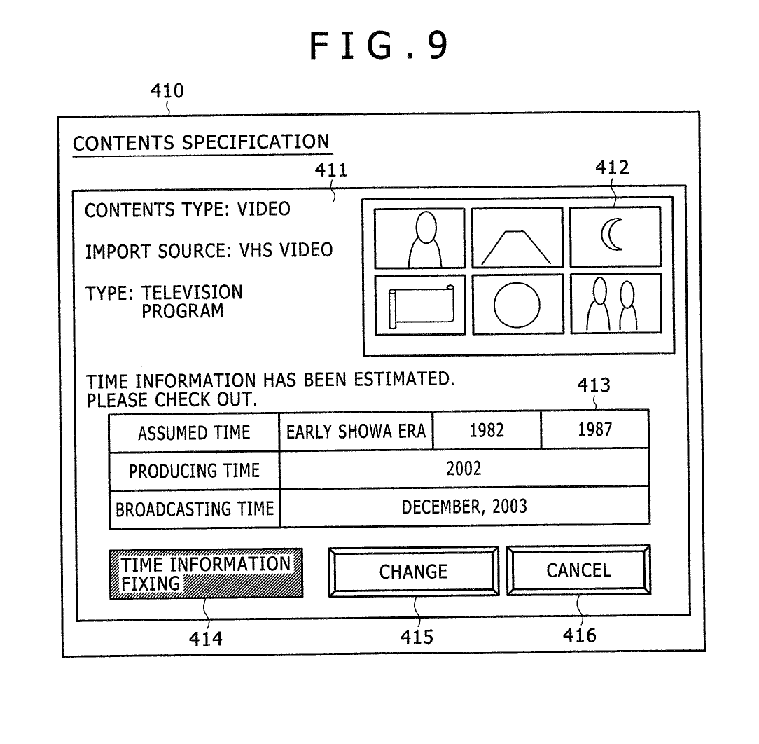

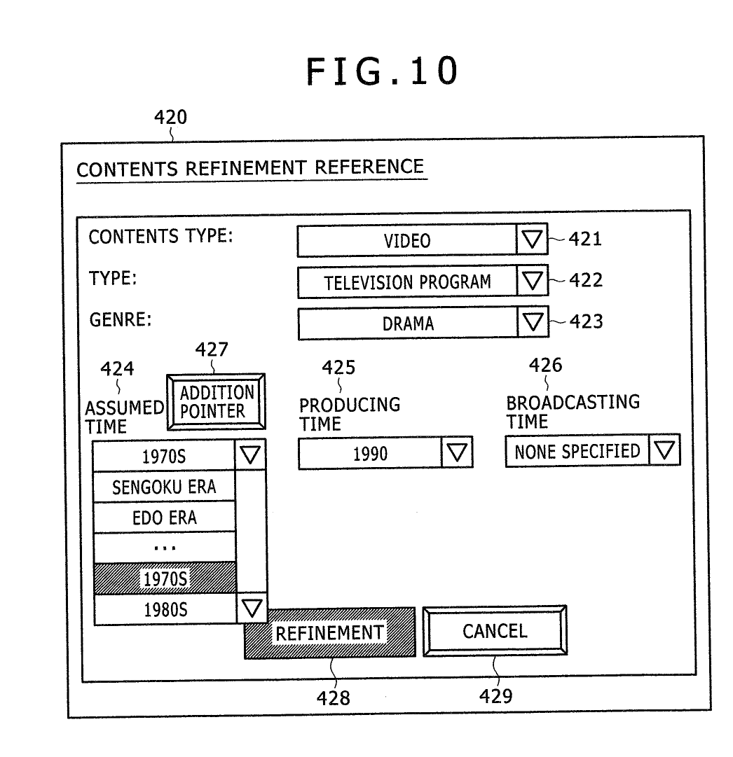

Next, FIGS. 9 and 10 show examples of screen displays of a user-oriented terminal according to this exemplary embodiment. FIG. 9 shows an example of a screen (corresponding step 308 of FIG. 5) which presents time information related to the contents to a user after estimated time data is obtained as metadata and is stored as contents metadata. The screen presents the story time, the created time, and broadcast time obtained from video contents of a television program imported from a VHS video by estimating according to the above-mentioned method and asks the confirmation of the user. If it is determined that the estimated time information is correct, “time information fixing” 414 is selected, and if a correction is required, “change” 415 is selected. When the “change” is selected, time information considered to be correct is received from the user (a choice considered to have a low degree of certainty in the estimating process may be selected), and according to the results, the matching data 120 and the metadata 130 stored in the server 001 are corrected.

FIG. 10 shows an example of a screen refining by referring to stored contents according to various conditions. In this example, refinement retrieval using conditions of story time 424, created time 425, and broadcast time 426 other than refinement conditions of a contents type 421, a type 422, and a genre 423 is possible. Here, as described above, since plural story times may be mixed in a scene for one video, plural choices can be selected by an “addition” button 427.

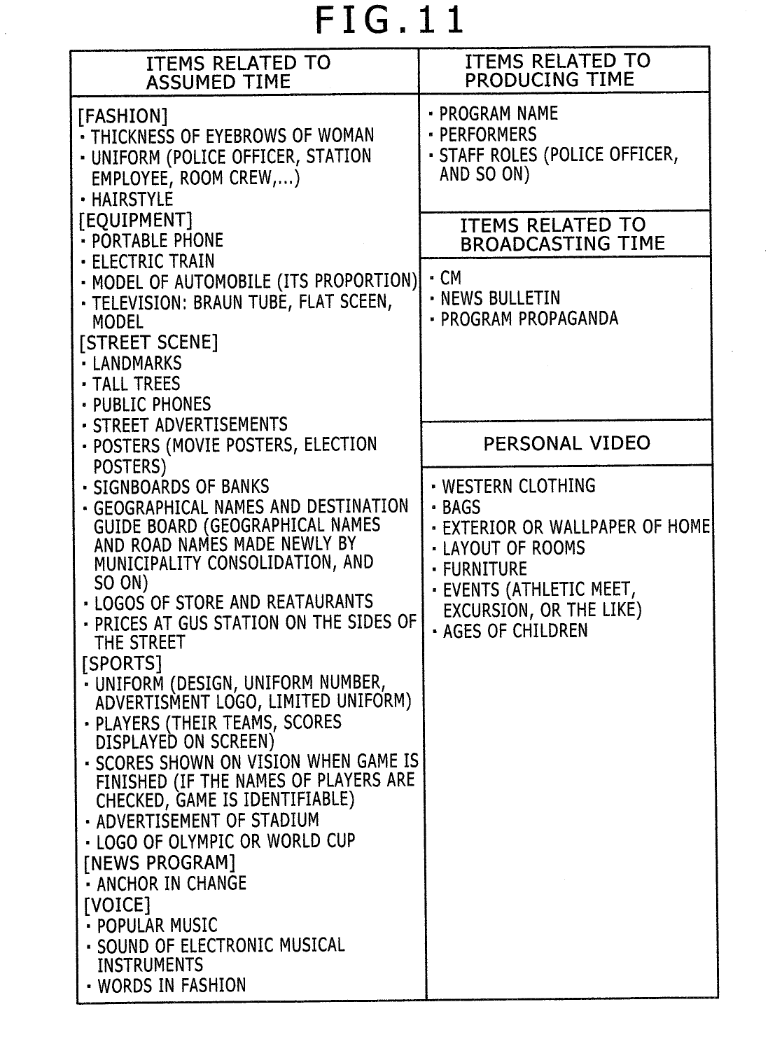

FIG. 11 shows some examples of items of the time information determination database. With respect to public data, regular maintenance is required. For example, a service provider registers the matching data 132 in advance and updates the degree of reliability on the basis of evaluation of estimation results. With respect to private data, since it is personal information and usage of the private data is limited, it is required that the user registers a predetermined amount of data in advance with respect to the ages of children, events, etc. Moreover, as a time information determination item, voice or letter information as well as images can be used as long as the information is used to determine time or an era from a video, but it is not limited to ones shown here.

### Second Embodiment

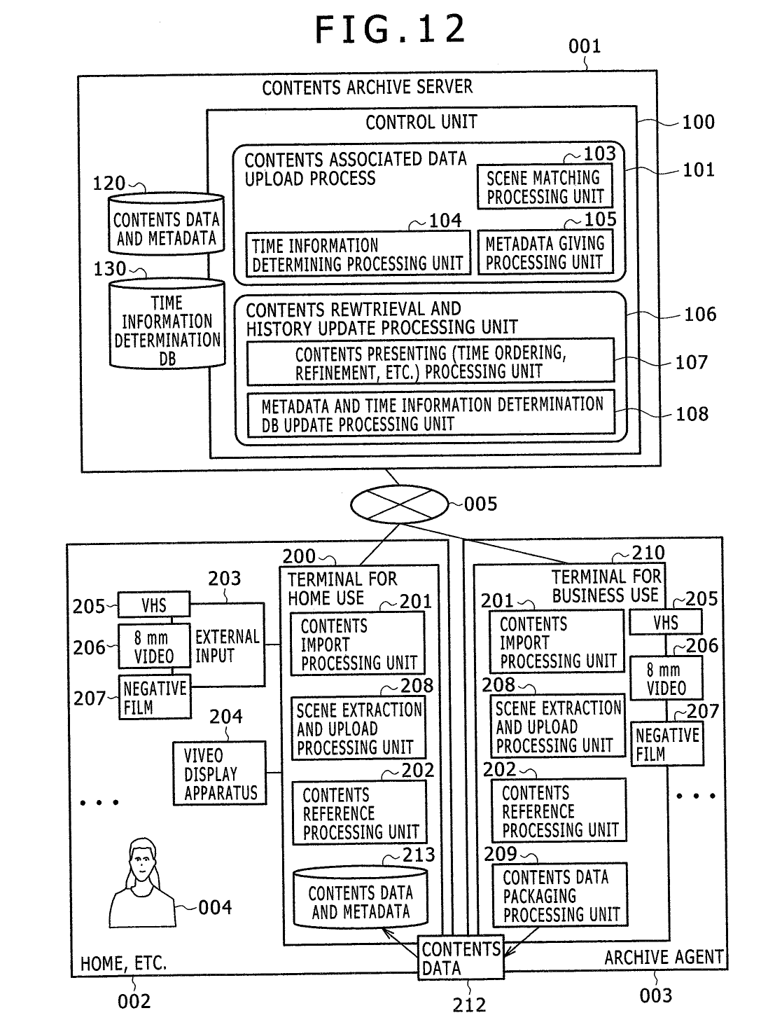

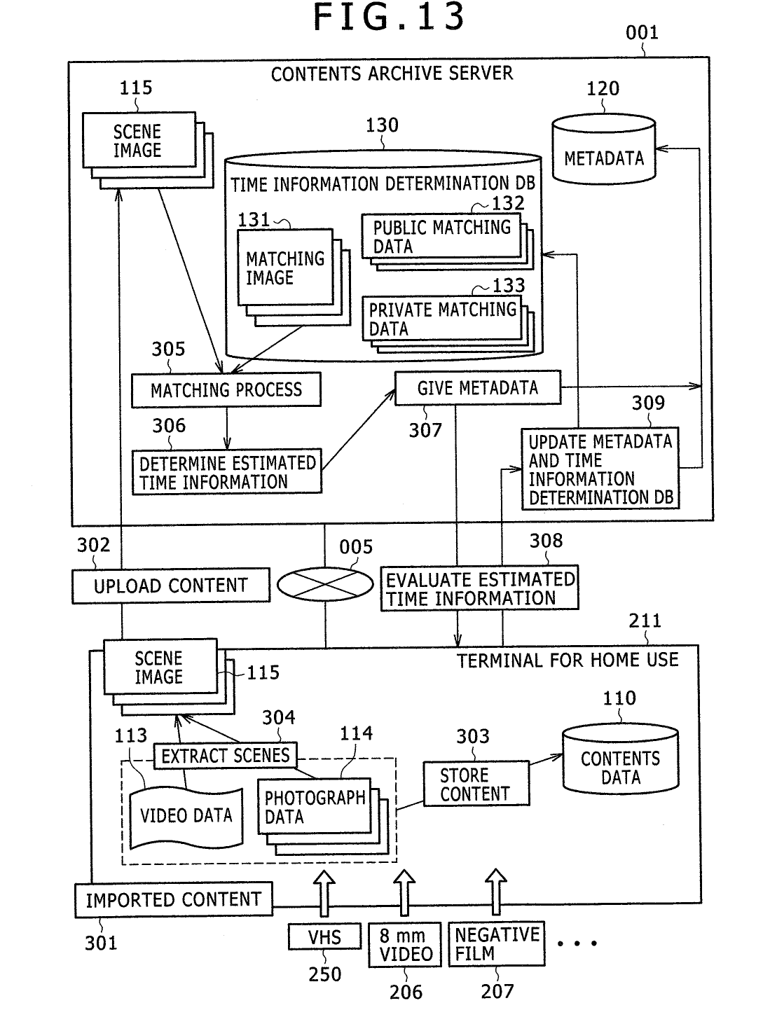

A contents storage (retrieval) system according to a second exemplary embodiment of the prevent invention will be described with reference to FIGS. 12 and 13. In the first exemplary embodiment, contents data is stored in the server 001. In contrast, in the second exemplary embodiment, a primary object of contents data is stored in a local DB (such as a terminal for home use) on the user side and only metadata is stored and managed in the server 001.

FIG. 12 is a diagram illustrating the whole structure of the contents storage (retrieval) system according to the second exemplary embodiment of the prevent invention. The main components are substantially the same as those in FIG. 1. However, a scene extracting unit 208 exists on a local side, in which only extracted representative images are uploaded to the server 001, and a process, such as time information determination, using the representative images is performed in the server. FIG. 13 is a flow chart of a contents storage and retrieval process according to the second exemplary embodiment and corresponds to the process flow according to the first exemplary embodiment shown as an example in FIG. 5. The imported contents are not uploaded to the server as they are, but a scene extracting process 304 is performed on the terminal side 211, and the extracted scene images 115 are uploaded to the server 001 (302). A primary object 110 of the contents is stored on the local side, not on the server side (303).

According to the apparatus and service described above, it is possible to provide a method of providing metadata, appropriate for facilitate retrieval or management, to video or image contents data having no metadata by means which is as user-friendly as possible. Therefore, the convenience of the user is improved.

It is possible to store a large amount of contents of a user or a contents distributor as digital contents having metadata and to provide a service to perform reference and inspection on the basis of the metadata. Moreover, it is possible to provide additional information on time to old contents of a corporation or an organization and to use the additional information to perform management.

What is claimed is:

1. A contents storage apparatus comprising a storage unit and a control unit,
wherein the storage unit includes:
a metadata storage unit for storing metadata associated with contents data stored in a contents data storage unit or contents data received through a network, and
a time information determination storage unit for storing matching images and time information associated with the matching images, and
the control unit performs
a matching process of matching images extracted from the contents data with the matching images,
a time information determination process of determining time information of the contents data from results of the matching process, and
a metadata providing process of providing time information related to the matching images to the contents data.

2. The contents storage apparatus according to claim 1,
wherein the time information includes one or more of a period when the contents had been broadcasted, a period when the contents had been created, and a period in which the setting of the contents is assumed.

3. The contents storage apparatus according to claim 1,
wherein the control unit selects the matching image having a high degree of similarity with an image extracted from the contents data from the matching images stored in the time information determination storage unit by the matching process, and performs an operation process in which the degree of similarity and a degree of reliability of time information associated with the selected matching image are used as variables.

4. The contents storage apparatus according to claim 3,
wherein when a plurality of the matching images are selected, the operation process in which the degree of similarity and the degree of reliability are used as variables is performed on the individual selected matching images and a cumulative total value of results of the operation process on the individual selected matching images is obtained.

5. The contents storage apparatus according to claim 3,
wherein when a plurality of images are extracted from the contents data, the operation process in which the degree of similarity and the degree of reliability are used as variables is performed on the individual extracted images and a cumulative total value of results of the operation process on the individual extracted images is obtained.

6. The contents storage apparatus according to claim 1,
wherein the matching images includes the matching images which can be used in common to users and the matching images which can be used by only a specific user.

7. A contents storage method which uses a storage unit and a control unit and stores contents in the storage unit on the basis of control of the control unit,
wherein the control unit performs:
a matching process of matching images extracted from the contents data stored in the storage unit with matching images,
a time information determination process of determining time information of the images extracted from the contents data on the basis of time information associated to the matching images, from results of the matching process, and
a metadata providing process of providing the time information associated with the matching images to the contents data, from the results of the time information determination process.

8. The contents storage method according to claim 7,
wherein the matching images having a high degree of similarity with the images extracted from the contents data are selected from the matching images stored in the storage unit by the matching process, and an operation process in which the degree of similarity and a degree of reliability of time information associated with the selected matching image are used as variables is performed.

9. The contents storage method according to claim 8,
wherein when a plurality of matching images are selected, the operation process in which the degree of similarity and the degree of reliability are used as variables is performed on the individual selected matching images and a cumulative total value of the results of the operation process on the individual selected matching images is obtained.

10. The contents storage method according to claim 8,
wherein when a plurality of images are extracted from the contents data, the operation process in which the degree of similarity and the degree of reliability are used as variables is performed on the individual extracted images and a cumulative total value of results of the operation process on the individual extracted images is obtained.

11. The contents storage method according to claim 7,
wherein the time information includes one or more of a period when the contents had been broadcasted, a period when the contents had been created, and a period in which the setting of the contents is assumed.

12. The contents storage method according to claim 7,
wherein the matching images include the matching images which can be used in common to all users and the matching images which can be used by only a specific user.

13. A contents retrieval terminal comprising:
a contents loading unit for loading contents;
an upload unit for uploading the contents to a contents storage apparatus through a network; and
a referring unit for referring to the contents stored in the contents storage apparatus,
wherein the referring unit displays a plurality of kinds of time information provided to the contents data on the basis of matching images and the plurality of kinds of time information associated with the matching images on a video display unit of the contents storage apparatus.

14. The contents retrieval terminal according to claim 13,
wherein the plurality of kinds of time information includes one or more of a period when the contents had been broadcasted, a period when the contents had been created, and a period in which the setting of the contents is assumed.
